(19) United States
(12) Patent Application Publication
(10) Pub. No.: US 2017/0347818 A1
(43) Pub. Date: Dec. 7, 2017

(54) COMPUTER-ENHANCED PORCELAIN WARES

(71) Applicant: Intel Corporation, Santa Clara, CA (US)

(72) Inventors: Jiqiang Song, Beijing (CN); Ying Gao, Beijing (CN); Guipeng Luan, Shanghai (CN); Dongping Liu, Shenzen (CN); Randolph Y. Wang, Santa Clara, CA (US); Wang Ho, Shanghai (CN); Haibing Xie, Shenzhen (CN); Bin Luo, Shenzen (CN); Zhanglin Liu, Beijing (CN); Yipeng Qu, Shenzhen (CN)

(73) Assignee: Intel Corporation, Santa Clara, CA (US)

(21) Appl. No.: 15/538,920

(22) PCT Filed: Jan. 23, 2015
(86) PCT No.: PCT/CN2015/071403

§ 371 Date: Jun. 22, 2017

(51) Int. Cl. A47G 19/22; G06F 1/16; G06F 3/041

(52) U.S. Cl. CPC A47G 19/2227; G06F 3/0412; G06F 1/1626; G06F 1/1643; G06F 1/1656

(57) ABSTRACT

A product includes a porcelain external wall, a touchscreen panel positioned behind the external wall, a graphical display panel positioned behind the external wall, graphical display logic to render a graphical user interface on the graphical display device to be projected through the porcelain external wall, and touch logic to interpret touch interactions with the touchscreen panel received through the porcelain external wall. The porcelain external wall at least partially obscures presentation of the graphical user interface.

### BACKGROUND

Smart phones, tablet computers, wearables, and other mobile computing devices have become very popular, even supplanting larger, more general purpose computing devices, such as traditional desktop computers in recent years. Increasingly, tasks traditionally performed on a general purpose computer are performed using mobile computing devices with smaller form factors and more constrained features sets and operating systems. Further, traditional appliances and devices are becoming “smarter” as they are equipped with functionality to connect to or consume content from the Internet. For instance, devices, such as televisions, gaming systems, household appliances, thermostats, automobiles, watches, have been outfitted with network adapters to allow the devices to connect with the internet (or another device) either directly or through a connection with another computer connected to the network. The interconnection of an increasingly large number of devices, or “things,” is believed to foreshadow a new era of advanced automation and interconnectivity, referred to, sometimes, as the Internet of Things (IoT).

As traditional products are made “smart” and integrated with computing logic, display devices, communication ports, and other features, the traditional version of the product is often redesigned to accommodate the new functionality. Presently, the ubiquitous design choice for integrating these high-tech features has been to redesign the conventional device into a modernized ersatz of the original. In the process, traditional materials and design aesthetics used in traditional versions of these products are often jettisoned as being incompatible either with the new functions or the new “modernized” design in favor of new materials, such as tempered or reinforced glasses, lightweight plastics, sleek metallic materials, among other examples.

### BRIEF DESCRIPTION OF THE DRAWINGS

The patent or application file contains at least one drawing executed in color. Copies of this patent or patent application publication with color drawing(s) may be provided by the Patent Office upon request and payment of any corresponding fees.

FIG. 1 illustrates one embodiment of a system in accordance with at least one embodiment.

FIG. 2 illustrates one embodiment of an example porcelain electronics device.

FIG. 3 illustrates one embodiment of a system including an example porcelain electronics device.

FIG. 4 illustrates views of an example porcelain electronics device including a touchscreen in accordance with at least one embodiment.

FIG. 5 illustrates an exploded view of one embodiment of a porcelain electronics device.

FIG. 6 illustrates a cross-sectional view of an example porcelain shell for use in at least one embodiment of a porcelain electronics device.

FIGS. 7A-7D illustrate one embodiment of an assembly of an example porcelain electronics device.

FIGS. 8A-8H illustrate another embodiment of an assembly of an example porcelain electronics device.

FIG. 9 illustrates one embodiment of a porcelain electronics device.

FIG. 10A illustrates an exploded view of another embodiment of a porcelain electronics device.

FIG. 10B illustrates a transparent view of an assembled embodiment of a porcelain electronics device.

FIGS. 11A-11B illustrate embodiments of a computing system.

FIG. 12 illustrates another embodiment of a computing system.

### DETAILED DESCRIPTION

The embodiments are generally directed to porcelain wares with integrated electronic components including touch display screens which display graphic presentations and accept touch gestures through a porcelain plate or wall. Various embodiments provide a system, apparatus and method that include a touchscreen module positioned behind a porcelain wall or plate. The porcelain is largely opaque in that the touchscreen module positioned behind the porcelain wall is hidden, particularly when the touchscreen is not in operation. When the touchscreen display is in operation and presents certain text or graphics, these graphics are projected through the porcelain wall for presentation to the user. Further, touch gestures of the user can be received at the porcelain wall and detected and interpreted by the touchscreen positioned behind the porcelain wall. The luxurious and old world style of porcelain can allow for more formal and classical products to be equipped with electronic and network connectivity capabilities. For instance, smart porcelain wares can be produced including smart mugs, smart bowls, smart vases, smart plates, smart cups, smart trophies, smart porcelain dolls, among other examples. Further, as porcelain is widely used in serving ware, smart plates, cups, bowls, and the like, can be integrated with software applications and programs that relate to food consumption and services, such as temperature and calorie monitoring, electronic menus, orders, and payment, and food reviews, among other examples.

Recent advances in mobile computing have put a premium on the sophistication of the features of the devices, with the design of the devices driven by the functionality. For instance, pixel density and display resolution have steadily improved with the displays of some tablet and smart phones surpassing the resolution of some high definition televisions. To preserve the quality of the graphics presented on such displays, many modern devices utilize hardened transparent glass, antiglare coatings, and other materials to shield the displays from scratches and abrasions, while guaranteeing that the full measure of the display's resolution is not impeded by the protective covering. However, in preserving the clarity of the display, little subtlety is preserved with the display often dominating the design and appearance of the device. However, it may desirable in some products, and to some customers, to hide or obscure the presence of a display in the device. Further, the use of modern designs and materials may be undesirable in at least some products, as some users seek a balance between functionality and design.

In the embodiments discussed below, one or more elements may be included. An element may comprise any structure arranged to perform certain operations. Each element may be implemented as hardware, software, or any combination thereof, as desired for a given set of design parameters or performance constraints. Although embodiments may be described with particular elements in certain arrangements by way of example, embodiments may include other combinations of elements in alternate arrangements.

It is worthy to note that any reference to “one embodiment” or “an embodiment” means that a particular feature, structure, or characteristic described in connection with the embodiment is included in at least one embodiment. The appearances of the phrases “in one embodiment” and “in an embodiment” in various places in the specification are not necessarily all referring to the same embodiment.

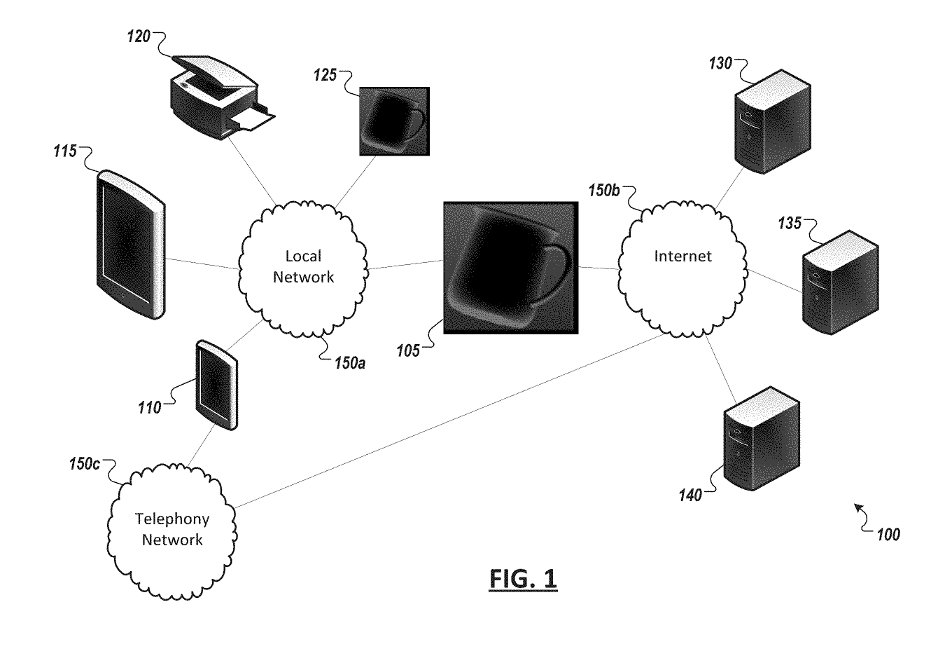

FIG. 1 illustrates a simplified block diagram 100 of one embodiment of a computing environment, or system, including a porcelain ware, or product 105, with an integrated display device for presenting a user interface of one or more software programs executable using one or more additional electronic devices incorporated in the product 105. The product 105 can include network adapters to allow the product 105 to communicatively couple to one or more other computing devices (e.g., 110, 115, 120, 125, 130, 135, 140) and/or networks (e.g., 145, 150, 155). In some implementations, the network adapter of the product 105 can allow the product to connect to the Internet 150b and consume web-based resources. For instance, one or more of the software programs executed on the product 105 can access or otherwise consume content from one or more server systems (e.g., 130, 135, 140). Further, the applications installed on the product 105 can be expanded, for instance, by downloading new applications from one or more sources.

The product 105 can also connect to other devices (e.g., 110, 115, 120, 125) using a local network connection (e.g., 150a). For instance, a WiFi or Bluetooth connection can be used to connect the product to a device with a higher resolution display and richer feature set, such as a smartphone 110 or tablet computer 115, among other examples. As an example, the product 105 can be used as a secondary user interface for accessing information stored or acquired by the smart phone 110, such as notices of received emails, phone calls, or text messages, among other examples. Further, the smartphone 110 (or other computing device) can be used to supplement the relatively limited user interface of the porcelain product. For instance, the keyboard, high resolution touchscreen, applications, and other components of the smart phone can be used to provide inputs or data to the product 105. In another example, the product 105 can be used in connection with a smartphone 110 capable of connecting to a telephony network 150c (such as a POTS network, cellular network, voice over IP network, etc.) and the product can serve as a Bluetooth telephone speaker and microphone through which the user participates in a phone conversation (facilitated through the smartphone), among other examples.

A porcelain electronics product 105 can also connect to peripheral devices (e.g., 120), such as printers, fax machines, kiosks, and storage devices. Further, the product 105 can connect to other porcelain electronics products (e.g., 125). For instance, one or more applications installed on the product 105 can facilitate games or activities that utilize two or more of such devices (e.g., 105, 125) participating in tandem within a session either locally or remotely. The product can also pair with or connect to other devices and systems and applications can be developed that make use of these pairings, such as a pairing between the porcelain electronics product 105 and an automobile's in-vehicle computer. As possible examples, the porcelain electronics product can be used as a portable music storage device that can access the car's speakers for playing a song, can be used to authenticate the owner of the car with the in-vehicle security system (e.g., to unlock doors or start the ignition), among other examples.

An electronics product 105 encased at least partially in porcelain may be provisioned with functionality similar to many other mobile computing devices. Given the porcelain (or other ceramic) material used in the product 105, the product 105 can additionally be used in ways other mobile computing devices would not. For instance, the product can be a utilitarian ware or decorative item formed at least in part with porcelain. For instance, the product 105 can take the form of a ceramic houseware item such as a cup, mug, plate, cookie jar, teapot, pitcher, or other item.

In various embodiments, a mobile computing device, including a mobile computing device incorporating a porcelain-covered touchscreen display, may comprise multiple nodes, element or components. A node, element or component generally may comprise any physical or logical entity in the mobile computing device and may be implemented as hardware, software, or any combination thereof, as desired for a given set of design parameters or performance constraints. Although the figures and description herein may present a limited number of nodes, elements and components by way of example, it can be appreciated that more or less nodes, elements or components may be employed for a given implementation.

In various embodiments, a mobile computing device may comprise a tablet computer, handheld computer, personal digital assistant (PDA), cellular telephone, combination cellular telephone/PDA, smartphone, portable computer, pager, messaging device, media player, digital music player, or other suitable mobile computing device. Various embodiments described herein include reference to a tablet computer. The embodiments are not limited in this context.

Mobile computing devices may comprise a device operative to form part of a wired communications system, a wireless communications system, or a combination of both. For example, the mobile computing device may comprise one or more nodes arranged to communicate information over one or more types of wired communication links. Examples of a wired communication link may include, without limitation, a wire, cable, bus, printed circuit board (PCB), Ethernet connection, peer-to-peer (P2P) connection, backplane, switch fabric, semiconductor material, twisted-pair wire, co-axial cable, fiber optic connection, and so forth. The mobile computing device 100 also may include one or more nodes arranged to communicate information over one or more types of wireless communication links. Examples of a wireless communication link may include, without limitation, a radio channel, infrared channel, radio-frequency (RF) channel. Wireless Fidelity (WiFi) channel, a portion of the RF spectrum, and/or one or more licensed or license-free frequency bands.

The mobile computing device 100 may communicate information in accordance with one or more standards as promulgated by a standards organization. In one embodiment, for example, various devices comprising part of the communications system 100 may be arranged to operate in accordance with one or more of the IEEE 802.11 standard, the WiGig Alliance™ specifications, WirelessHD™ specifications, standards or variants, such as the WirelessHD Specification, Revision 1.0d7, Dec. 1, 2007, and its progeny as promulgated by WirelessHD, LLC (collectively referred to as the “WirelessHD Specification”), or with any other wireless standards as promulgated by other standards organizations such as the International Telecommunications Union (ITU), the International Organization for Standardization (ISO), the International Electrotechnical Commission (IEC), the Institute of Electrical and Electronics Engineers (information IEEE), the Internet Engineering Task Force (IETF), and so forth. In various embodiments, for example, the mobile computing device 100 may communicate information according to one or more IEEE 802.11 standards for wireless local area networks (WLANs) such as the information IEEE 802.11 standard (1999 Edition, Information Technology Telecommunications and Information Exchange Between Systems—Local and Metropolitan Area Networks—Specific Requirements, Part 11: WLAN Medium Access Control (MAC) and Physical (PHY) Layer Specifications), its progeny and supplements thereto (e.g., 802.11a, b, g/h, j, n, VHT SG, and variants); IEEE 802.15.3 and variants; IEEE 802.16 standards for WMAN including the IEEE 802.16 standard such as 802.16-2004, 802.16.2-2004, 802.16e-2005, 802.16f, and variants; WGA (WiGig) progeny and variants; European Computer Manufacturers Association (ECMA) TG20 progeny and variants; and other wireless networking standards. The embodiments are not limited in this context.

A computing device may communicate, manage, or process information in accordance with one or more protocols. A protocol may comprise a set of predefined rules or instructions for managing communication among nodes. In various embodiments, for example, a communications system may employ one or more protocols such as a beam forming protocol, medium access control (MAC) protocol, Physical Layer Convergence Protocol (PLCP), Simple Network Management Protocol (SNMP), Asynchronous Transfer Mode (ATM) protocol, Frame Relay protocol, Systems Network Architecture (SNA) protocol, Transport Control Protocol (TCP), Internet Protocol (IP), TCP/IP, X.25, Hypertext Transfer Protocol (HTTP), User Datagram Protocol (UDP), a contention-based period (CBP) protocol, a distributed contention-based period (CBP) protocol and so forth. In various embodiments, the communications system 100 also may be arranged to operate in accordance with standards and/or protocols for media processing. The embodiments are not limited in this context.

In some embodiments, the computing device may include or be associated with a network and a plurality of other nodes. In various embodiments, the nodes may be implemented as various types of wireless or mobile computing devices. Examples of wireless devices may include, without limitation, an IEEE 802.15.3 piconet controller (PNC), a controller, an IEEE 802.11 PCP, a coordinator, a station, a subscriber station, a base station, a wireless access point (AP), a wireless client device, a wireless station (STA), a laptop computer, ultra-laptop computer, portable computer, personal computer (PC), notebook PC, tablet computer, handheld computer, personal digital assistant (PDA), cellular telephone, combination cellular telephone/PDA, smartphone, pager, messaging device, media player, digital music player, set-top box (STB), appliance, workstation, user terminal, mobile unit, consumer electronics, television, digital television, high-definition television, television receiver, high-definition television receiver, and so forth.

In some embodiments, a computing device may comprise or include one more wireless interfaces and/or components for wireless communication such as one or more transmitters, receivers, transceivers, chipsets, amplifiers, filters, control logic, network interface cards (NICs), antennas, antenna arrays, modules and so forth. Examples of conventional antennas may include, without limitation, an internal antenna, an omni-directional antenna, a monopole antenna, a dipole antenna, an end fed antenna, a circularly polarized antenna, a micro-strip antenna, a diversity antenna, a dual antenna, an antenna array, and so forth.

In various embodiments, a mobile computing device may comprise or form part of a wireless network. In some embodiments, for example, the wireless network may comprise or be implemented as various types of wireless networks and associated protocols suitable for a WPAN, a Wireless Local Area Network (WLAN), a Wireless Metropolitan Area Network, a Wireless Wide Area Network (WWAN), a Broadband Wireless Access (BWA) network, a radio network, a television network, a satellite network such as a direct broadcast satellite (DBS) network, a long term evolution (LTE) network and/or any other wireless communications network arranged to operate in accordance with the described embodiments.

Computing devices (including porcelain electronics devices) may comprise a processor circuit and/or memory in some embodiments. A processor may comprise any suitable electric device, semiconductor device, system on chip or other component in some embodiments. For example, a processor may comprise a multi-core processor in various embodiments. In some embodiments, a processor may include or comprise one or more radio modules or combination transmitter/receiver (e.g. transceiver) devices. In various embodiments, the transceiver device may comprise a device that has both a transmitter and a receiver that are combined and share common circuitry or a single housing. For example, in some embodiments, the transceiver may be operative to enable wireless communication capabilities for a mobile computing device (e.g., 105). Other embodiments are described and claimed.

Memory may comprise any suitable physical device operative to store data, programs, sequences of instructions or other information on a temporary or permanent basis for use in mobile computing device in some embodiments. For example, memory may comprise volatile or non-volatile memory, RAM, ROM, virtual memory, solid state disk drive or a hard disc drive for example. The embodiments are not limited in this context.

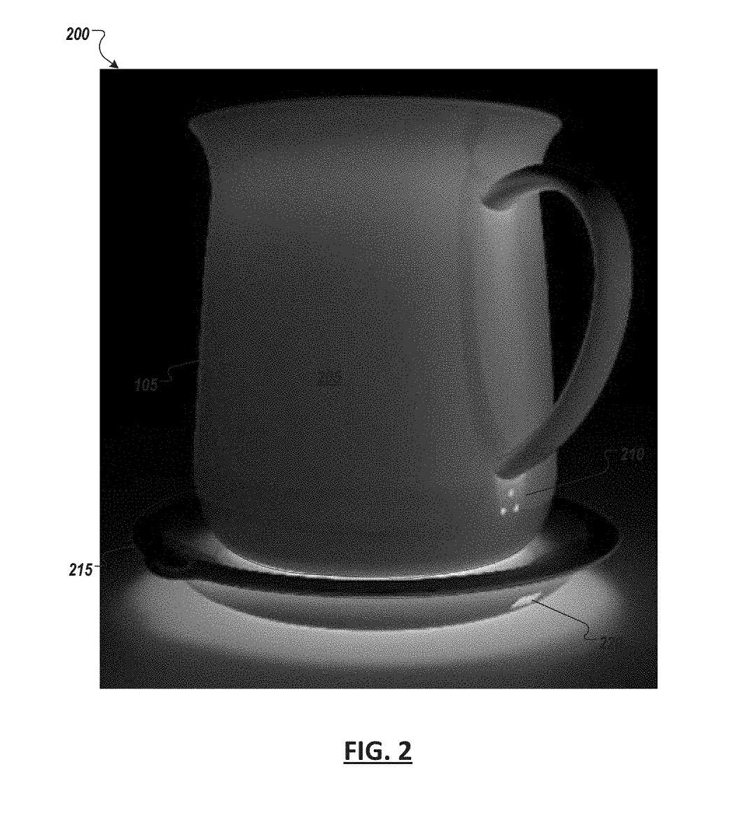

FIG. 2 is an illustration 200 of an example implementation of a porcelain electronics product 105. In the particular example of FIG. 2, the product is embodied as a smart porcelain mug. One of the walls 205 of the smart mug covers a touchscreen display embedded within the porcelain mug. The presence of the display is hidden when the display is not in operation given the opaque nature of the porcelain wall 205. However, the porcelain wall 205 is at least partially translucent to allow light to pass through the porcelain wall, in this case, light emitted from the underlying touchscreen display. Further, the touchscreen can sense touch gestures received at the wall's surface 205. Additional electronic components can be encapsulated within the interior of the smart mug, such as processors, memory, buses, and other sensors that can assist in providing the user interfaces presented using the display device embedded within the smart mug. For instance, the smart mug can be equipped with a microphone and speaker and miniature perforations 210 can be provided (with membrane coverings to waterproof the internal components) to provide an audio/voice interface for the smart mug. The smart mug can be a functional mug in that it provides an opening and cavity serving as a vessel for liquids or non-liquid contents, including human consumable contents (e.g., coffee, ice cream, etc.). Accordingly, in some implementations, it may be desirable to configure the smart mug such that it can be submersed in water and allow cleaning of the mug's interior. As such, openings that might expose the sensitive internal electronic elements of the mug can be limited (e.g., to small holes 210 of only a few millimeters in diameter) and may be themselves sealed, for instance, using a membrane that waterproofs the interior of the mug but allows sound (either input or output) to reach interior sensors (e.g., microphone, gyro, accelerometer, thermistors, etc.), among other examples. Further, wireless power charging capabilities may be provided in the mug to do away with another port or connection (e.g., for a direct current adapter) that may limit the mug's ability to be exposed to water. In the particular example of FIG. 2, a coordinating saucer 215 is illustrated to serve as a wireless charging transmitter to deliver power to the wireless charging receiver of the mug 105 (e.g., to charge a battery of the smart mug), among other features. The saucer may be provided with ports (e.g., 220) such as for a power cord or input/output (I/O) cable or storage device (e.g., a USB port). In such cases, the saucer 215 can also be provided with a wireless transceiver to communicate data from the I/O port at the saucer to the smart mug 105 in addition to charging the battery of the smart mug 105, among other example features.

It should be appreciated that the example of FIG. 2 (as well as the other illustrations of the Figures) is provided for purposes of illustration only and should not be interpreted as limiting the types of porcelain wares that could be constructed with features and functionality similar to that described for a smart mug (or any other example porcelain electronics product described) herein. For instance, principles of this disclosure can be applied to a wide variety of porcelain wares, including other vessels (e.g., vases, trophy cups, jugs, pitchers, pots, bowls, cups, saucers, etc.) as well as other porcelain wares (e.g., porcelain dolls, statutes, plates, tiles, etc.).

Porcelain can refer to ceramic or glass materials that possess the general physical characteristics attributable to porcelain such as its strength, hardness, impermeability, and opaque yet translucent quality. Porcelain can be further characterized by a glazed, hard, glass-like surface, and can include materials that are completely vitrified, hard, impermeable (even before glazing), white or artificially colored, translucent (except when of considerable thickness), and resonant. For instance, porcelain can include fired ceramics formed from clay bodies such as kaolinite, feldspar, ball clay, glass, bone ash, steatite, quartz, petuntse, and alabaster. For instance, bone porcelain, composed of clay and bone powder, can be used, among other porcelain types, because of better translucence levels or other desired characteristics.

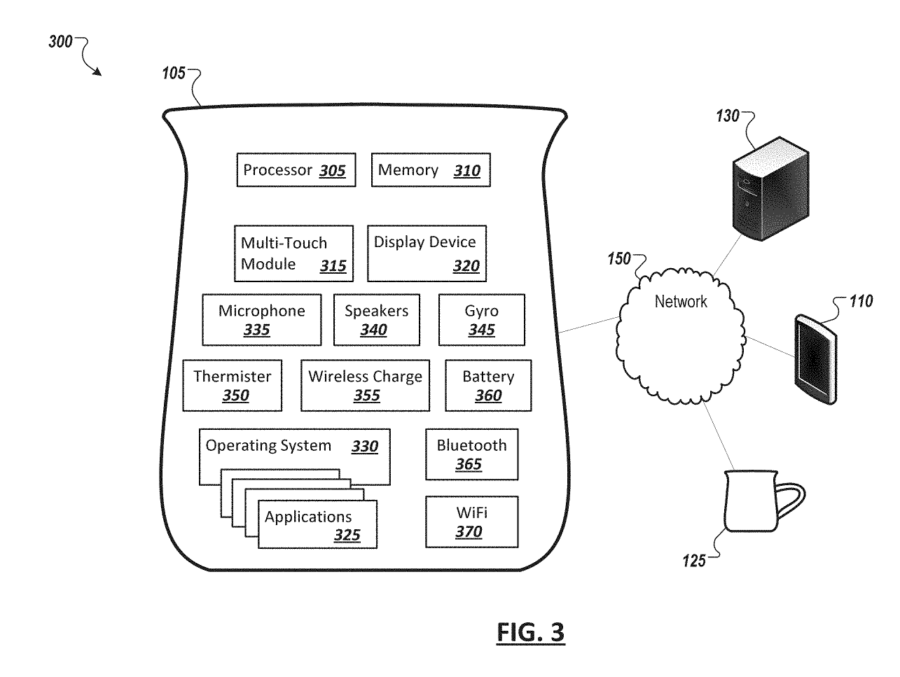

FIG. 3 shows a simplified block diagram 300 illustrating example electronic components included in an example porcelain product 105. The porcelain product 105 can include one or more computer processing apparatus 305, and one or more memory elements 310. Additional components can be provided, at least some of which include logic implemented in hardware and/or software that are stored in a memory element 310 and/or executed by a processor 305. The porcelain product can include a touchscreen display module that includes, in some instances, a multi-touch module 315 (such as a capacitive touch panel) and a display device 320 (such as a light-emitting diode (LED)-based display). The porcelain can cover both the touch module 315 and display device 320 hiding the inclusion of the touchscreen in the product 105 but allowing a user to view a graphical user interface projected by the display device 320 through the porcelain and interact with the touch module 315 by touching the surface of the porcelain. The graphical user interfaces (GUIs) can correspond to one or more applications 325 installed on the product (e.g., in memory 310) and running (in some implementations) in an operating system 330. Some of these applications and programs can make use of other sensors provided with the product 105. For instance, the product 105 can include a microphone 335, speakers 340, a gyroscope 345 (for sensing movement (tilt, rotation, etc.) of the product), and a thermistor 350 (e.g., to sense temperature of the product or substances in contact with the product (such as the temperature of a beverage in a smart mug), among other examples. For instance, additional sensors may include one or more of a camera, accelerometer, proximity sensor, light sensor, compass or global positioning system (GPS) in some embodiments.

Additionally, applications 325 of product 105 can interact with other devices (e.g., 110, 125, 130) outside of the product 105, obtain and consume content from the other devices, and even send content to the other devices. For instance, network adapter logic and one or more transceivers can be provided within the product 105 to implement a Bluetooth module 365 or WiFi 370 module, among other examples, to allow the product 105 to communicate wirelessly with other devices (e.g., 110, 125, 130) using such wireless communication technologies and networks (e.g., 150). For instance, one or more local wireless connections can be established to allow the product to communicatively couple to other devices local to it (e.g., a smart phone 110, or another porcelain electronics product 125 (e.g., a smart mug)). The product 105 can also access resources of remote devices (e.g., server 130) using wide-area networks (WAN), such as the Internet. In some cases, the product 105 can connect to the Internet directly and communicate directly with backend services (e.g., 130) to access data or consume services that can supplement the functionality of the application logic (e.g., 325) of the product 105. In other cases, the product 105 can access data, services, storage, processing, and other resources of remote systems (e.g., 130) through another device, such as a general purpose computing device (e.g., a tablet, laptop, or smartphone 110) communicatively coupled to the product using a local wireless connection.

In some implementations, the product 105 can be mobile in that its form factor allows transportation and use in a variety of locations. A mobile product 105 can include one or more batteries 360. In some cases, battery 360 can be rechargeable. A variety of charging mechanisms can be used to re-charge the battery 360. In some implementations, the battery 360 of product 105 can be recharged wirelessly using a wireless charging module 355. The wireless charging module 355 can comprise a wireless charging receiver that can wirelessly accept electromagnetic energy emitted by a wireless charging transmitter (not shown) that is in close proximity to the product 105. The wireless charging module 355 can direct this energy to the recharging of battery 360.

In some embodiments, a display device 320 may be implemented as an LED array. In other instances, display device 320 can potentially comprise any suitable visual interface for displaying content to a user through a porcelain surface. In one embodiment, for example, the display 320 may be implemented by a liquid crystal display (LCD) or a touch-sensitive color LCD screen. In other embodiments, display 320 may comprise a plasma display, light-emitting diode (LED) display or an organic light-emitting diode (OLED) display. A display implemented as a touchscreen module can be responsive to human touch or may be used with a stylus and/or a handwriting recognizer program in some embodiments. Touch module 315 can be implemented by a variety of touch recognition technologies, including capacitive touch technology, among other examples that permit touch inputs received at a porcelain surface covering the touch module to be recognized.

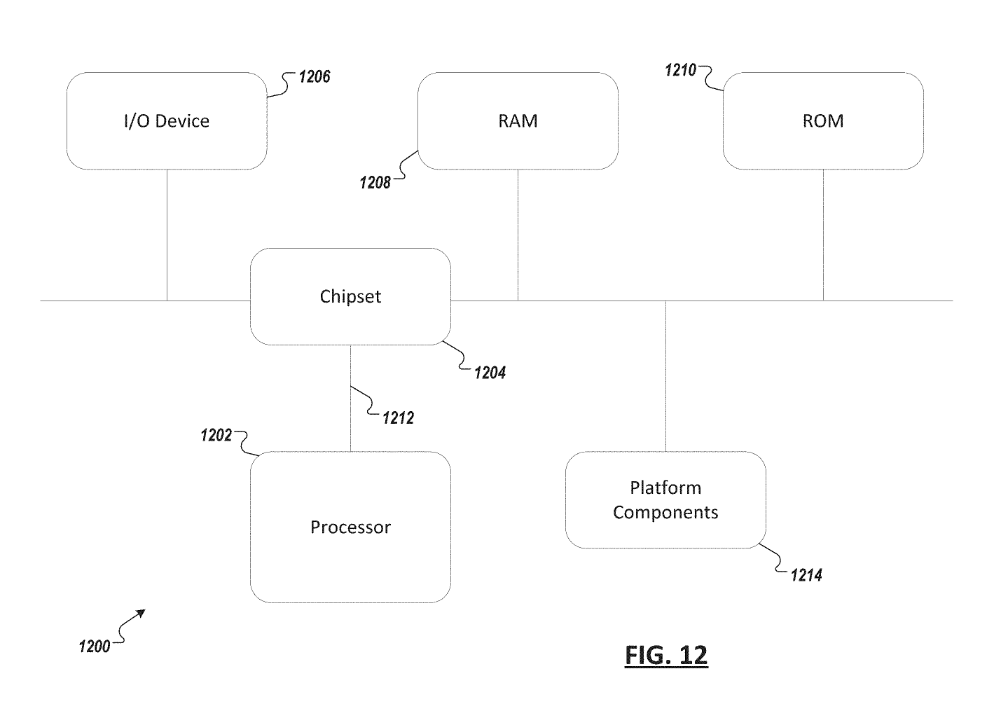

While the embodiments are not limited in this context, FIG. 2 illustrates one possible implementation of a porcelain electronics product in some embodiments. While a limited number and arrangement of components are shown in FIG. 2 for purposes of illustration, it should be understood that a product 105 may include any number or arrangement of components and still fall within the described embodiments. The embodiments, however, are not limited to the elements or the configuration shown in this figure. Additional components for a mobile computing device (which may be incorporated in an embodiment of a porcelain electronics product 105) are discussed in further detail below with reference to FIG. 12.

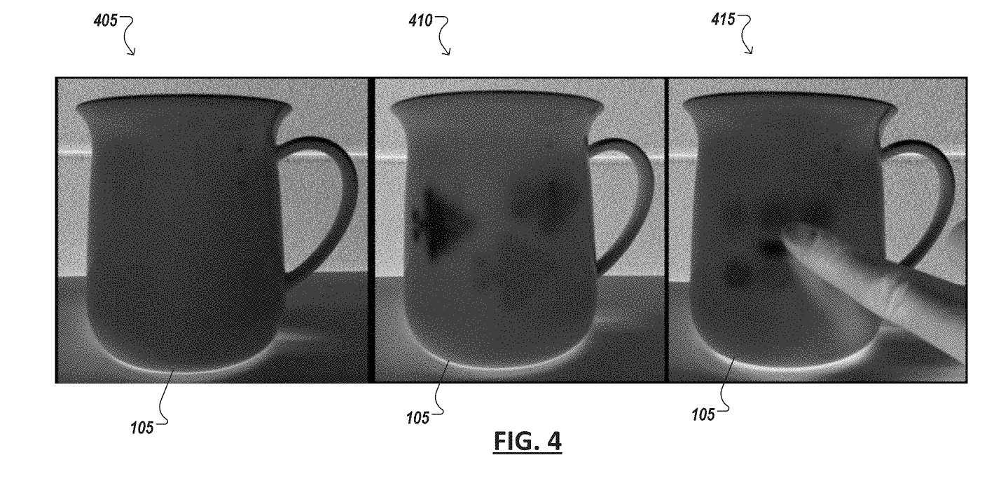

FIG. 4 illustrates a touchscreen display incorporated in a porcelain electronics product 105. In this particular example, the porcelain electronics product 105 is embodied as a smart mug (similar to the example of FIG. 2). In view 405, the display is either powered-down, idle, or in another state in which no GUI or related text or images are being displayed. As no (or little) light is being emitted from the display positioned behind the porcelain surface of the product 105, the product (a mug) appears as a “normal” version of the porcelain ware (i.e., one that does not possess a touchscreen display or associated components and logic). The opaque nature of the porcelain surface hides the presence of the touchscreen display. However, as shown in view 410, when graphics are displayed on the touchscreen display, these are projected through the at least partially translucent porcelain surface. In some cases, the porcelain can diffuse the images projected through it by the display device such that they appear with a lower resolution and “softer” aesthetic than might be found in higher resolution displays on more traditional personal electronics devices. Further, a user may interact with the graphics (embodying a GUI of an application hosted on the porcelain electronics product 105) by touching the porcelain surface and engaging a touch module beneath the porcelain surface, as shown in view 415. In some cases, the touch module can support a variety of different touch gestures such as vertical and/or horizontal swipes, touches, multi-touches, pinches, etc. In some cases, the touch inputs can be supplemented by other interfaces on the product, including speech recognition modules facilitated by an embedded microphone. Further, gyroscopic or acceleration sensors embedded in the product can also be used to provide an enhanced user interface for the product. One or more electromechanical buttons (e.g., a power or home button) can also be provided in some cases to supplement the touchscreen interface, among other example implementations.

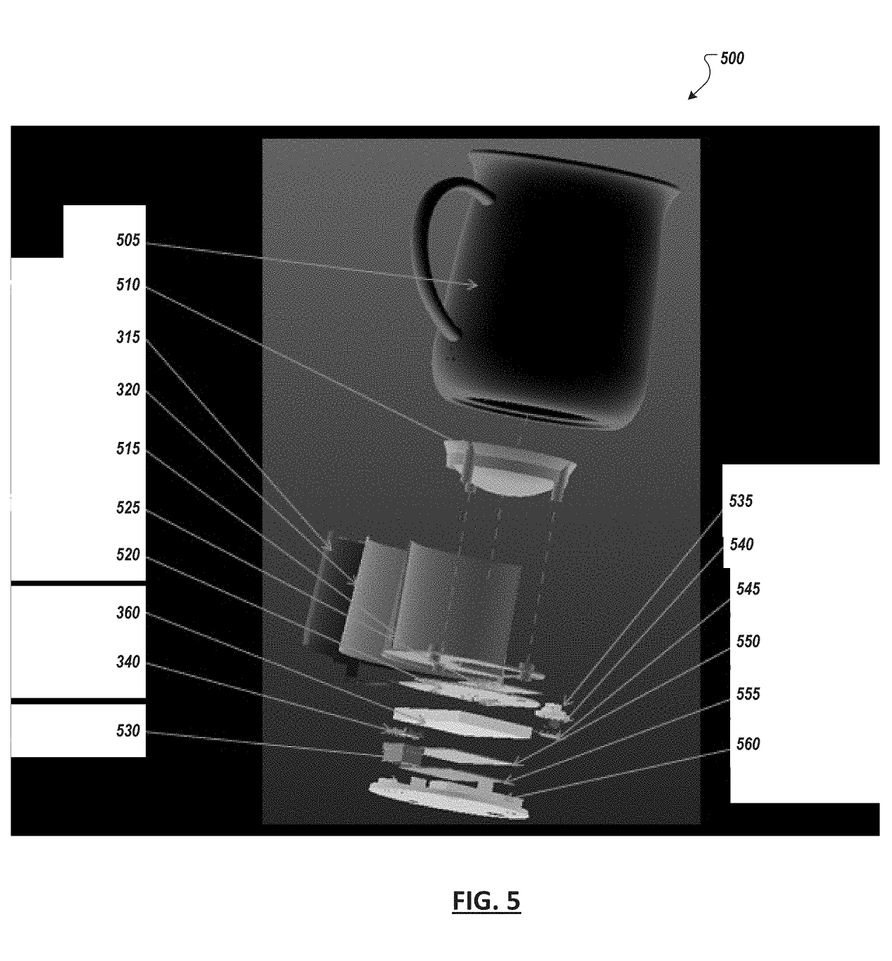

FIG. 5 illustrates an exploded view 500 of one implementation of a porcelain electronics product, in this case implemented as a smart porcelain mug. For instance, a porcelain shell 505 is provided with an internal compartment for housing a touchscreen module and one or more additional electronic components within the product. A fixture 510 is provided and can be bonded to a surface of the shell's 505 inner compartment. The fixture can be composed from a rigid plastic or other material and can be used to secure other components to the interior of the product. For instance, other components can be connected to the fixture 510, which is bonded or otherwise secured to the shell's interior. For instance, a plastic display device holder 515 can be secured, with screws, to the fixture 510. The display device holder can be configured to connect to and secure the display device 320 (in this example, an LED array) within the compartment formed by the porcelain shell 505. In this example, the exterior surface of the shell is curved and the display device 320 can be curved to correspond to the geometry of the shell. A touch panel 315 can also be provided and can be positioned within the shell's compartment between the display device 320 and the porcelain shell 505. The display device 320 and touch panel 315 can be electrically connected to an I/O board 520 to permit communication between the display device 320, touch panel 315, and other electronic components, including a processor chip and memory provided on processor component 525. Additional components can include a rechargeable battery 360, speaker component 340, speaker holder 530 and components (e.g., 535, 540, 545) for providing a power button. For instance, the power button can be composed of a power switch 540 to be mounted on switch holder 535 and covered by an external button 545. Further, in this example, a wireless charging module is provided, embodied as a receiver coil 555. A shielding sheet 550 can be provided to shield the electronic components (e.g., 520, 525) from the receiver coil 555. Finally, a bottom piece 560 is provided as a cover for enclosing the components (e.g., 315, 320, 340, 360, 510, 515, 520, 525, 530, 535, 540, 545, 550, 555, etc.) within the inner compartment of the shell 505. The bottom piece 560, in some cases, can also serve to seal the inner compartment and protect it from liquid and other elements that can degrade and threaten the functionality of the product's internal components.

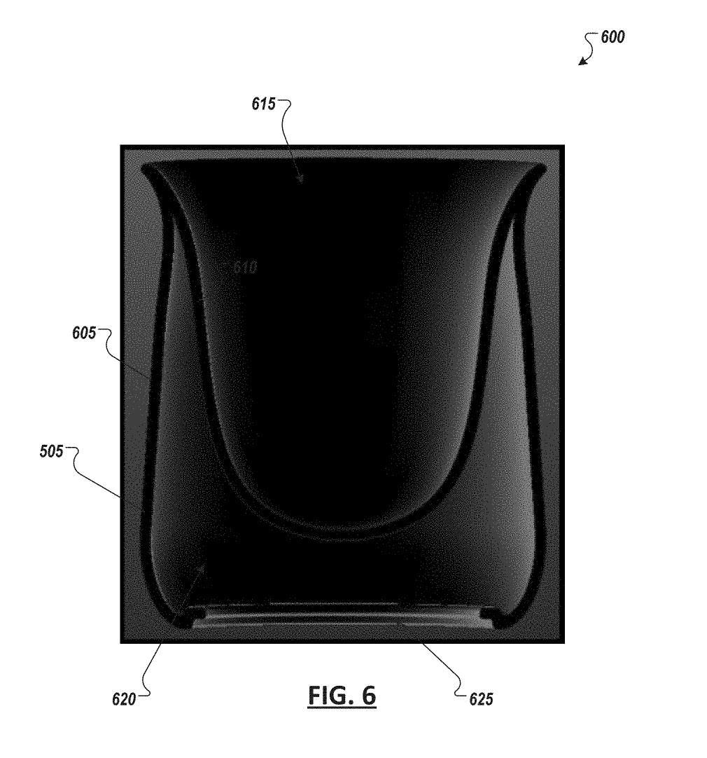

FIG. 6 shows a cross-sectional view 600 of an example porcelain shell for accepting and housing electronic components within a porcelain electronics product. In the example of FIG. 6, the porcelain shell 505 of the example smart porcelain mug of FIG. 5 is illustrated. In this example, the shell 505 forms a double-walled vessel including an exterior wall 605 and interior wall 610 that serves as the side wall of the vessel cavity 615. The space between the walls 605, 610 and below the vessel cavity 615 is a hollow compartment 620 in which the touchscreen module and other electronic and supporting components can be placed (e.g., through bottom opening 625). The wall (e.g., 605) of the product that is to serve as the screen of the display device can have a thickness that promotes transmission of light from the display device through the wall, while at the same time providing a minimum level of thickness to preserve the structural strength of the wall and the product. For instance, the wall through which the touchscreen module is to operate can have a thickness between 2.5 mm and 4 mm. In one implementation, the thickness of the wall can be 2.8 mm. Other thickness ranges may be appropriate in some implementations, such as implementations using differing porcelain types, among other factors.

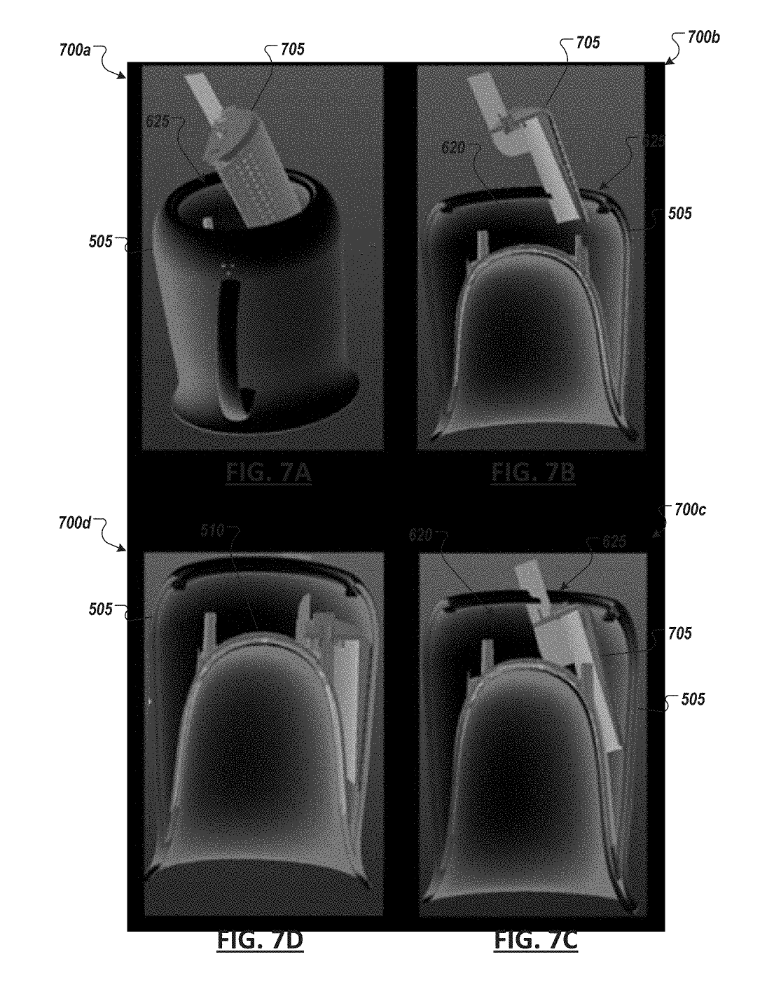

FIGS. 7A-7D illustrate one example of the installation of a touchscreen module 705 into the hollow compartment 620 of the shell 505 through opening 625. The touchscreen module 705 can be inserted through the opening 625 (as shown in the view 700a of FIG. 7A) and positioned between the interior and exterior walls of the shell 505 (as shown in the views 700b-c of FIGS. 7B-7C). The screen of the touchscreen module can be oriented to project light through the exterior wall of the shell 505. The display holder of the touchscreen module 705 can then be aligned with the fixture 510 attached to the interior wall, as shown in the view 700d of FIG. 7D. The touchscreen module 705 can then be secured to the fixture 510, and thereby the shell 505.

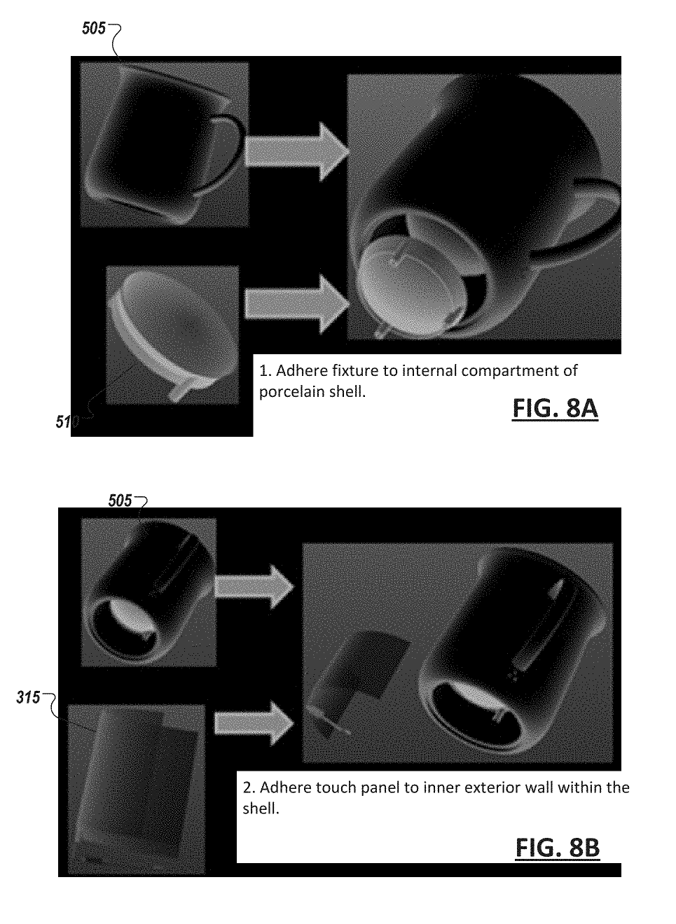

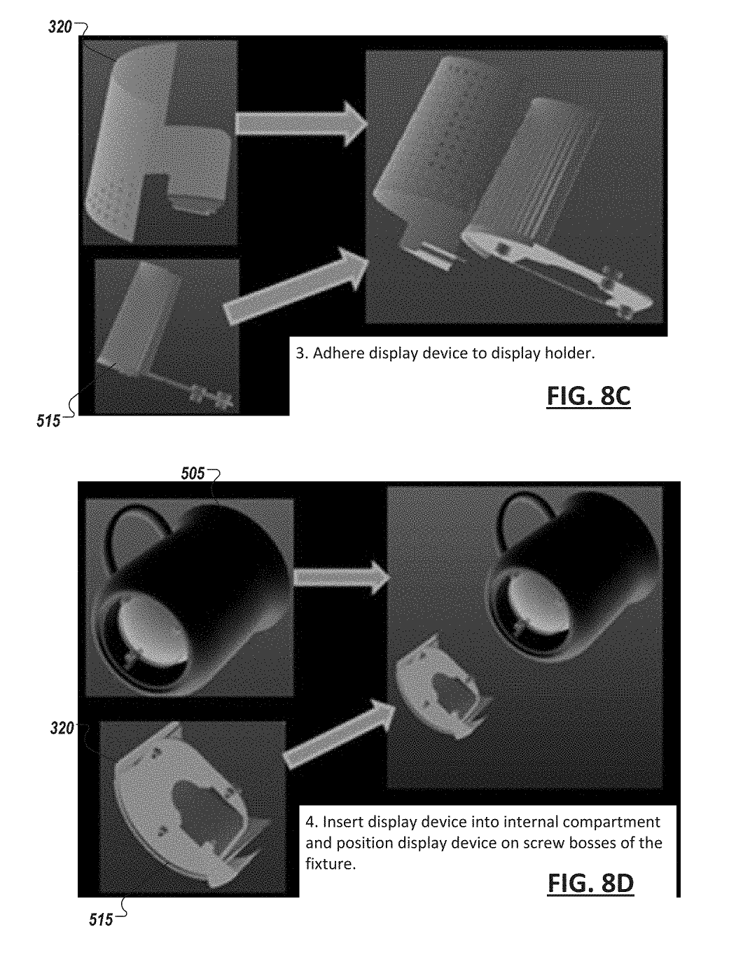

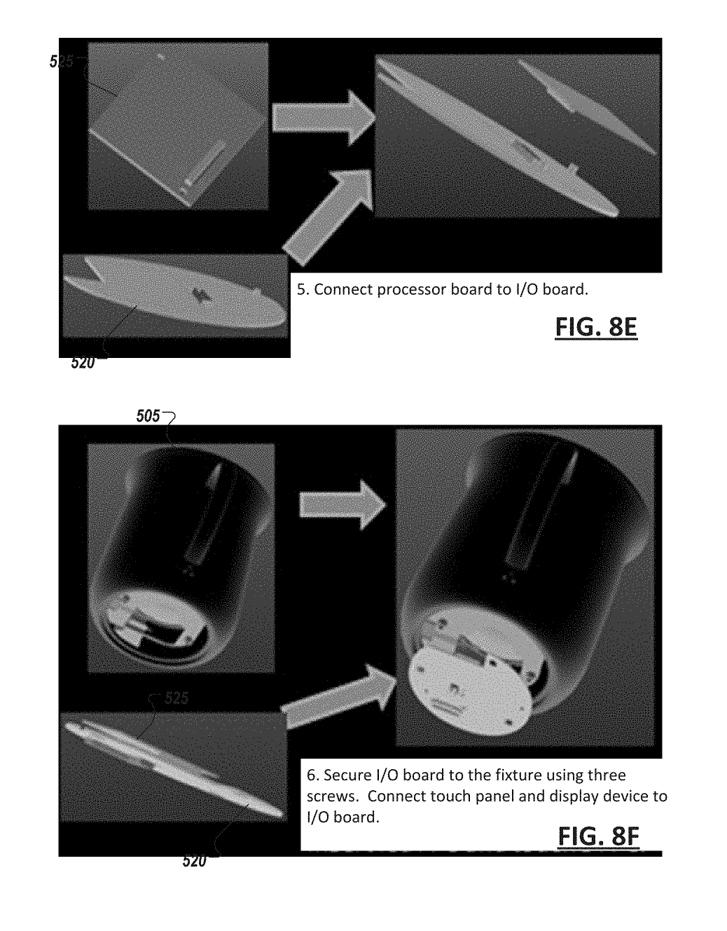

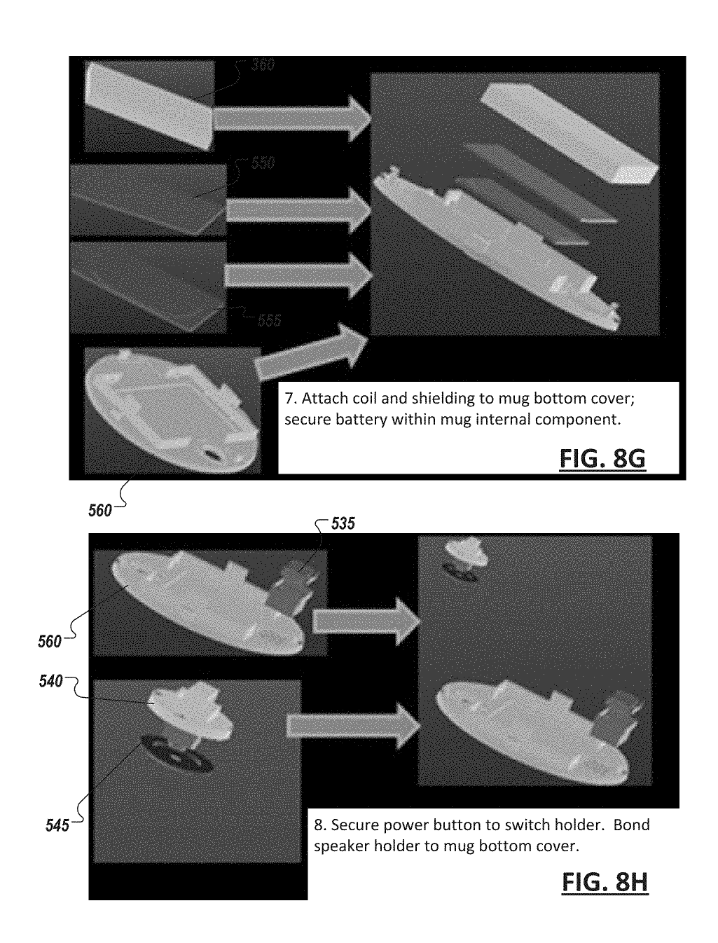

FIGS. 8A-8H show additional views 800a-h of an example construction of a smart porcelain mug employing a touchscreen display provided behind a porcelain surface. For instance, in FIG. 8A, a fixture 510 can be passed through the opening of the porcelain shell 505 and bonded to the interior of the porcelain shell 505. As the porcelain shell may not be equipped to accept screws and other mechanical connections, the adhered fixture 510 can act as an extension of the shell and can be configured to accept screws, rivets, or other mechanical connectors to secure other components of the smart mug within the compartment of the shell 505. For instance, screw bosses can be provided on the fixture 510 for use in securing one or more components within the shell's interior compartment. As shown in FIG. 8B, the touch panel 315 can be adhered to conform to the exterior wall of the shell within the interior compartment of the shell 505. In some cases, the touch panel can be adhered to the shell 505 prior to the fixture 505.

As shown in FIG. 8C, the display module can be constructed by adhering a flexible electronic display panel 320 to a plastic display holder 515. The display holder can be molded to conform to the geometry of the porcelain shell and adhering the display panel to the display holder 515 can cause the display panel to conform to the exterior wall of the shell (i.e., the screen covering for the touch. The assembled display 320 and display holder 515 can be passed through the opening of the porcelain shell 505 and can be aligned with the fixture secured within the shell 505, as illustrated for instance in FIG. 8D. For instance, holes can be provided in the screen holder 515 and these holes can be aligned with screw bosses provided on the fixture, among other examples.

Turning to FIG. 8E, a processor 525, consisting, in this example, of a system on chip or processor board including one or more processors and supporting components, can be connected to an I/O board 520. The I/O board can serve as the fabric for interconnecting one or more other electronic components of the porcelain electronics product with the processor. In some cases, these other electronic components can also be mounted on or integrated with the I/O board 520. As shown in FIG. 8F, the I/O board can be configured to be able to pass through the opening of the shell and attached to the fixture secured within the shell's 505 interior compartment (e.g., by aligning holes in the board 520 with screw bosses on the fixture). The display and touch panels can be connected to the I/O board 520.

Turning to FIG. 8G, a wireless charging receiver can be assembled, including a battery 360, shielding 550, and receiver coil 555. The components (e.g., 360, 550, 555, etc.) of the wireless charging receiver can be aligned with a frame provided on the bottom cover 560. The wireless charging receiver can be connected to the I/O board to allow battery capacity and re-charging to be monitored as well as to power components of the IO board, including the processor. As shown in FIG. 8H, additional components can also be secured to the bottom cover 560 of the porcelain electronic product. For instance, the power button for the product can be positioned on the bottom of the smart mug using the bottom cover 560. In the example of FIG. 8H, a switch holder 535 can be secured to the bottom cover 560. Components (e.g., switch 540 and switch button/cover 545) can be secured to the bottom cover 560 using the switch holder 535. With the components positioned on the cover 560 and within the shell, the components can be enclosed within the shell by connecting and sealing the cover 560 to the shell and thereby covering the opening to the interior compartment of the shell.

One or more processors within embodiments of a porcelain electronics product can execute code of one or more software programs that can utilize electronic components and sensors of the product to perform a variety of corresponding tasks and interface with users through a touchscreen display positioned behind an exterior porcelain wall of the product. Such programs can include a clock and calendaring application, weather forecast reporting application, text message application, email client application, a variety of different game applications, temperature sensing application, music player application, voice recorder applications, camera applications, screensaver or other animation applications, among other examples.

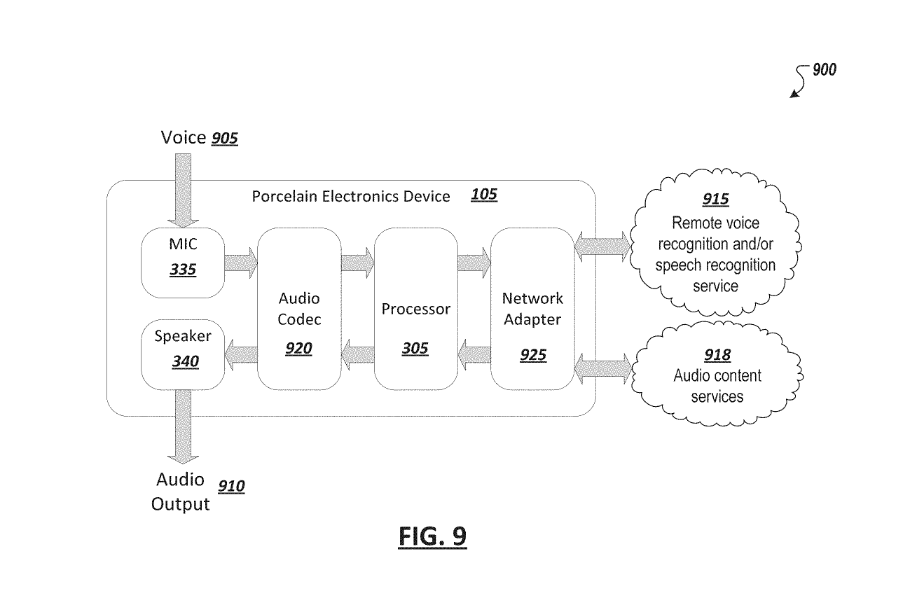

The touch display interface of a porcelain electronics product can be supplemented by a voice interface in some implementations. Turning to FIG. 9, a simplified block diagram 900 is illustrated showing an example implementation of a voice and speech recognition module that can be provided in some embodiments of a porcelain electronics product 105. In one example, voice inputs 905 can be received through a microphone 335 and passed to an audio codec block 920 to encode the voice input 905 into data for processing by processor 305. In some instances, voice and/or speech recognition logic may be provided within the electronic product 105. In other instances, the porcelain electronics product 105 can outsource this functionality to cloud or other remote services (e.g., 915). For instance, remotely provided speech and voice recognition services 915 can be accessed by the porcelain electronics product 105 over one or more networks using network adapted 925. For instance, at least a portion of the voice data generated from voice input 905 can be sent to a remote service 915 for processing. The remote service 915, in response, can send outputs of the speech and/or voice recognition processing for consumption by the processor 305 and one or more applications of the porcelain electronics product 105. For instance, voice recognition can be used, for instance, to authenticate the user of the porcelain electronics product 105, the voice input 105 serving as a voice signature of the user. Speech recognition can be used to allow voice inputs 905 to be interpreted and processed as user inputs to one or more applications. For instance, a voice input can be used as an input to an application such as a text messaging or email application, as a command to open a particular one of the applications or navigate within a particular application, to activate certain functionality of the porcelain electronics product 105, among other examples. Data can also be received from various remote services 915, 918 and can be converted (e.g., using audio codec block 920) into an audio output 910 in connection with one or more applications (e.g., an online radio or podcast streaming application) presented using one or more speakers 340.

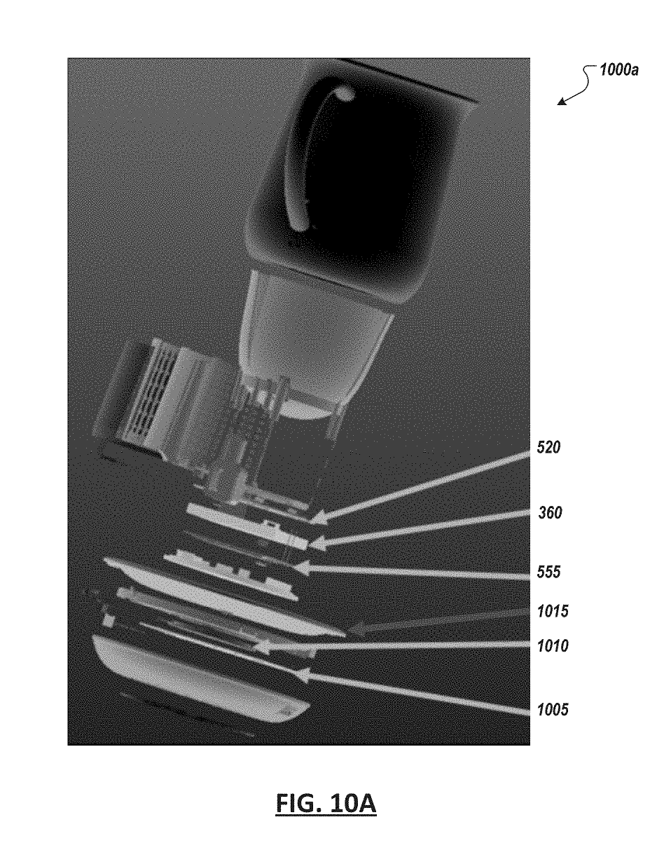

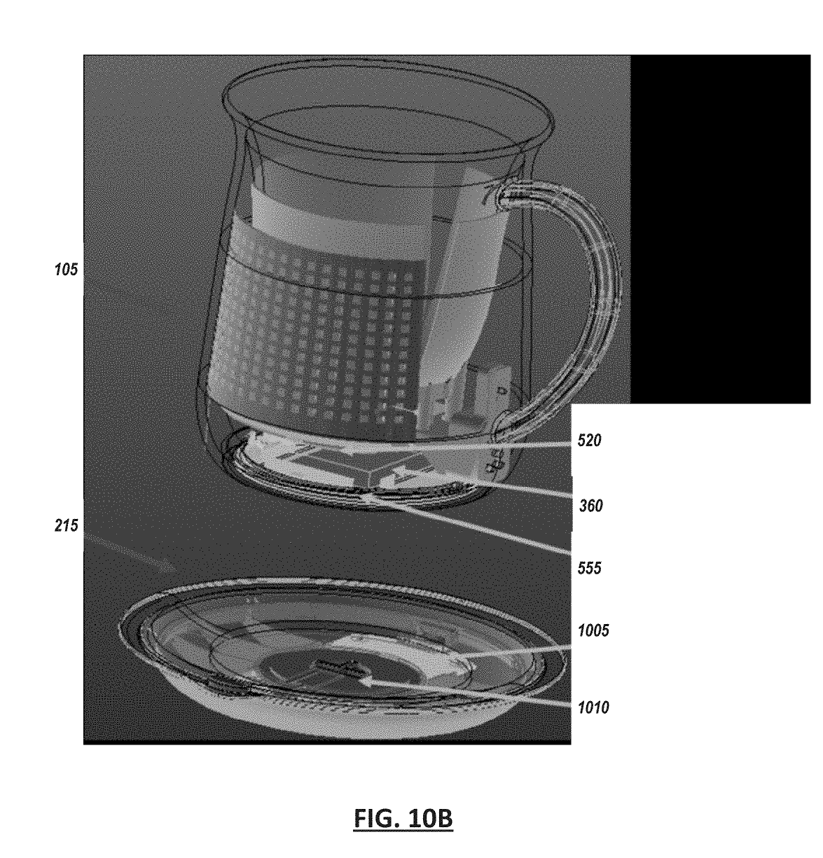

As noted above, in some implementations, a porcelain electronics product can utilize wireless charging to recharge power storage modules of the product. This can allow ports, such as a DC adapter port, to be eliminated for instance, to minimize openings into the product and assist in waterproofing the product. FIG. 10A shows an exploded view 1000a of an embodiment of a porcelain electronics product that includes a wireless charging receiver for use with a wireless charging transmitter (also illustrated in the exploded view 1000a). FIG. 10B shows an alternate, transparent view 1000b showing the porcelain electronic device 105 and wireless charging transmitter 215 as assembled with their component elements (e.g., 360, 520, 555, 1005, 1010). For instance, the wireless charging receiver includes a rechargeable battery 360 and receiver coil 555 controlled by components of I/O/control board 520. In the example of FIG. 10A, the porcelain electronics product is implemented as a porcelain mug paired with a wireless charging transmitter embedded in a coordinating porcelain saucer. For instance, the wireless charging transmitter can include a transmitting coil 1005 controlled by a control board 1010 and associated processor and logic. The transmitting coil 1005 and control board 1010 are embedded within an enclosure, embodied as a saucer 1015 to cover the wireless charging transmitter and conveniently accept the smart porcelain mug device (thereby bringing the wireless charging receiver into range of the wireless charging transmitter).

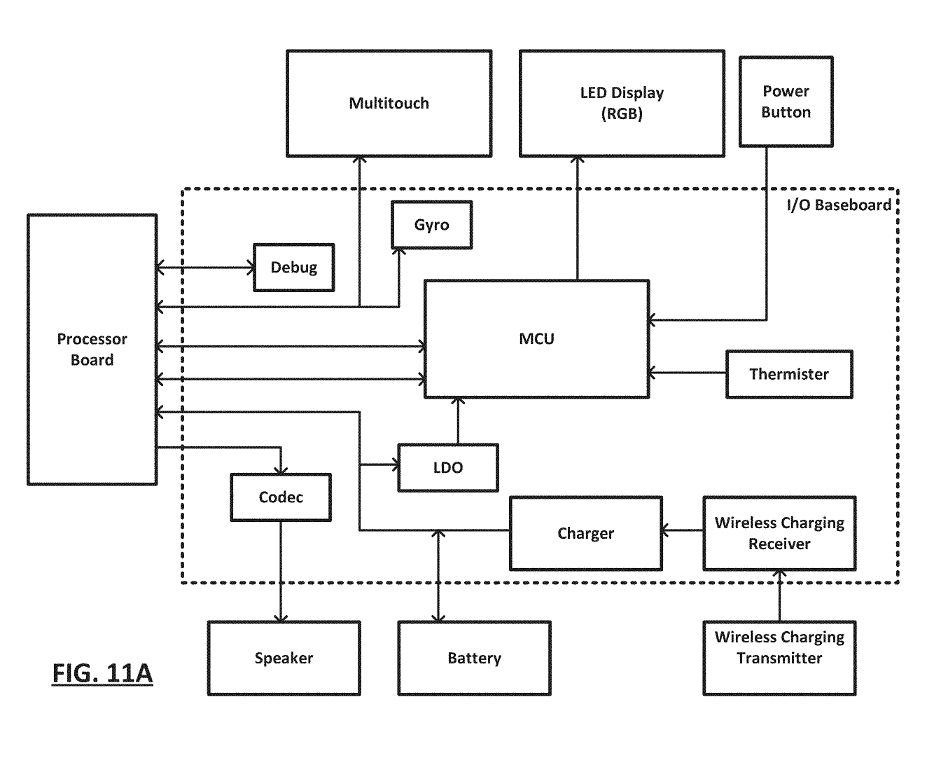

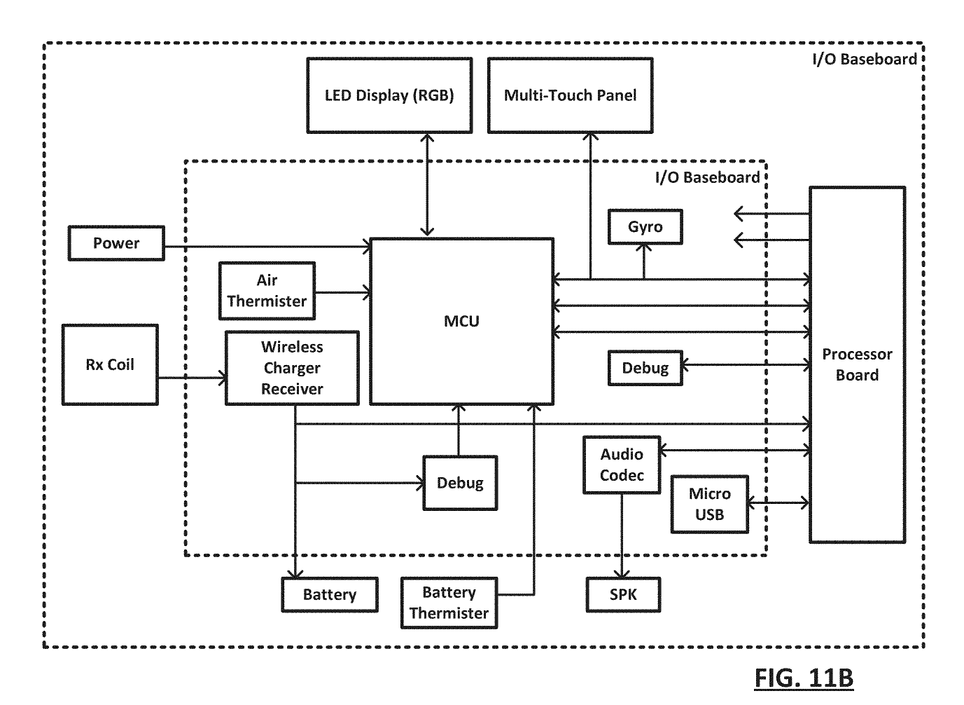

In some implementations, a higher powered system-on-chip including one or more processors, or processing cores, can be utilized in an implementation of a small form factor network-enabled device, such as a porcelain electronics device or other handheld or wearable mobile device. FIG. 11A shows a simplified block diagram 1100a of one general example implementation of a board for use in one such device. FIG. 11B provides a specific example of a board for use in a smart porcelain mug. In either example, a processor board 1105 can include the system on chip and other components that can apply higher level processing, for instance, to execute logic of one or more applications and the operating system of the device. However, in some implementations of a mobile or wearable device, it can be desirable to provide some functionality while the processor board is off or idle, thereby saving power. Further, from a user experience standpoint, it can be desirable to provide quick start-up of the device in response to a user input to power on the device. However, powering up and initializing the system on chip of processor board 1105 may take longer than is suitable to provide the user with the desired quick turn on response. Accordingly, in some implementations, a separate microcontroller 1110 can be provided on an I/O board 520 to supplement the system on chip. In some instances, the microcontroller 1110 can serve as the taskmaster of the system on chip, in the sense that it powers-on and powers-down the system on chip of the processor board 1105 and, in some cases, delegates tasks to the processor board, among other examples.

In the particular example of FIG. 11A, the microcontroller (MCU) 1110 is to handle functionality that is to remain active even when the system on chip is powered down. Such functions might include managing charging of the device (through a wireless charging receiver module), providing battery capacity information to the user (allowing the user to understand the charge level of the device without having to fully awaken the system on chip), monitor health of the battery (e.g., using a battery thermistor), among other specialty functions. For instance, for a smart mug, a core function may be to detect and present temperate readings of the contents of the mug (e.g., using a smart mug). For a smart watch or garment, a core specialty function may be to detect steps, heartbeat, muscle contractions, nerve signals, body temperature, etc., and the microcontroller can control the functioning and data delivered by related sensors in the device (i.e., even when the higher-powered system on chip is powered down). The MCU can remain powered on or idle in that it can be quickly reawakened relative to the system on chip. Indeed, the MCU may be powered on and down orders of magnitude quicker than the system on chip, allowing the user to quickly reengage the device (using the MCU) without having to wait for the system on chip to re-awaken and provide the full functionality of the device. Further, the MCU can control the display device, for instance, to display user interfaces related to functionality it controls as well as in instances where the display device utilizes an I/O incompatible with the system on chip, among other examples.

In instances, where an MCU 1110 is used in a centralized homogenous system that also includes a higher level system on chip processor board 1105, a data bus or chip level communication interface (e.g., an I2C bus, Universal Asynchronous Receiver/Transmitter (UART), etc.) can be provided to enable communication between the MCU 1110 and processor board 1105. Further, an interrupt can be defined for use by the MCU 1110 is waking-up the system on chip. The MCU can present a user interface to a user in response to the press of an “on” button or other user input while the system on chip (SoC) re-awakens, providing the illusion that the device is fully functional in nearly instantaneous response to the user's input. A software layer can be defined to abstract and hide the heterogeneity of the SoC-MCU dichotomy, giving the appearance (to applications on the device) of a single processor apparatus. In instances where the MCU has sole control of the display device, the MCU can further receive inputs from the SoC in connection with SoC-managed tasks and drive display of corresponding graphical user interfaces on the display device (e.g., a red-green-blue (RGB) LED array display), among other examples activities and features. Through such implementations, a platform independent SoC and processor board package 1105 may be reusable across multiple different mobile device products, with the simpler MCU being used to tailor inclusion of the SoC into specific mobile device implementations, among other example benefits.

FIG. 12 is a diagram of an exemplary system embodiment. Features of this system can be implemented in some embodiments of a porcelain electronics device or other mobile computing devices. The example of FIG. 12 shows a diagram showing a system 1200, which may include various elements. For instance, FIG. 12 shows that system 1200 may include a processor 1202, a chipset 1204, an input/output (I/O) device 1206, a random access memory (RAM) (such as dynamic RAM (DRAM)) 1208, and a read only memory (ROM) 1210, and various platform components 1214 (e.g., a fan, a crossflow blower, a heat sink, DTM system, cooling system, housing, vents, and so forth). These elements may be implemented in hardware, software, firmware, or any combination thereof. The embodiments, however, are not limited to these elements.

As shown in FIG. 12, I/O device 1206, RAM 1208, and ROM 1210 are coupled to processor 1202 by way of chipset 1204. Chipset 1204 may be coupled to processor 1202 by a bus 1212. Accordingly, bus 1212 may include multiple lines.

Processor 1202 may be a central processing unit comprising one or more processor cores and may include any number of processors having any number of processor cores. The processor 1202 may include any type of processing unit, such as, for example, CPU, multi-processing unit, a reduced instruction set computer (RISC), a processor that have a pipeline, a complex instruction set computer (CISC), digital signal processor (DSP), and so forth.

Although not shown, the system 1200 may include various interface circuits, such as an Ethernet interface and/or a Universal Serial Bus (USB) interface, and/or the like. In some exemplary embodiments, the I/O device 1206 may comprise one or more input devices connected to interface circuits for entering data and commands into the system 1200. For example, the input devices may include a keyboard (physical or virtual/soft), mouse, touch screen, track pad, track ball, isopoint, a voice recognition system, and/or the like. Similarly, the I/O device 1206 may comprise one or more output devices connected to the interface circuits for outputting information to an operator. For example, the output devices may include one or more displays, printers, speakers, and/or other output devices, if desired. For example, one of the output devices may be a display. The display may be a cathode ray tube (CRTs), liquid crystal displays (LCDs), LED, or any other type of display.

The system 1200 may also have a wired or wireless network interface to exchange data with other devices via a connection to a network. The network connection may be any type of network connection, such as an Ethernet connection, digital subscriber line (DSL), telephone line, coaxial cable, etc. The network may be any type of network, such as the Internet, a telephone network, a cable network, a wireless network, a packet-switched network, a circuit-switched network, and/or the like.

Numerous specific details have been set forth herein to provide a thorough understanding of the embodiments. It will be understood by those skilled in the art, however, that the embodiments may be practiced without these specific details. In other instances, well-known operations, components and circuits have not been described in detail so as not to obscure the embodiments. It can be appreciated that the specific structural and functional details disclosed herein may be representative and do not necessarily limit the scope of the embodiments.

Various embodiments may be implemented using hardware elements, software elements, or a combination of both. Examples of hardware elements may include processors, microprocessors, circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), logic gates, registers, semiconductor device, chips, microchips, chip sets, and so forth. Examples of software may include software components, programs, applications, computer programs, application programs, system programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. Determining whether an embodiment is implemented using hardware elements and/or software elements may vary in accordance with any number of factors, such as desired computational rate, power levels, heat tolerances, processing cycle budget, input data rates, output data rates, memory resources, data bus speeds and other design, performance or cost constraints.

Some embodiments may be described using the expression “coupled” and “connected” along with their derivatives. These terms are not intended as synonyms for each other. For example, some embodiments may be described using the terms “connected” and/or “coupled” to indicate that two or more elements are in direct physical or electrical contact with each other. The term “coupled,” however, may also mean that two or more elements are not in direct contact with each other, but yet still co-operate or interact with each other.

Some embodiments may be implemented, for example, using a machine-readable or computer-readable medium or article which may store an instruction, a set of instructions or computer executable code that, if executed by a machine or processor, may cause the machine or processor to perform a method and/or operations in accordance with the embodiments. Such a machine may include, for example, any suitable processing platform, computing platform, computing device, processing device, computing system, processing system, computer, processor, or the like, and may be implemented using any suitable combination of hardware and/or software. The machine-readable medium or article may comprise a non-transitory medium in some embodiments and may include, for example, any suitable type of memory unit, memory device, memory article, memory medium, storage device, storage article, storage medium and/or storage unit, for example, memory, removable or non-removable media, volatile or non-volatile memory or media, erasable or non-erasable media, writeable or re-writeable media, digital or analog media, hard disk, floppy disk, Compact Disk Read Only Memory (CD-ROM), Compact Disk Recordable (CD-R), Compact Disk Rewriteable (CD-RW), optical disk, magnetic media, magneto-optical media, removable memory cards or disks, various types of Digital Versatile Disk (DVD), a tape, a cassette, or the like. The instructions may include any suitable type of code, such as source code, compiled code, interpreted code, executable code, static code, dynamic code, encrypted code, and the like, implemented using any suitable high-level, low-level, object-oriented, visual, compiled and/or interpreted programming language.

Unless specifically stated otherwise, it may be appreciated that terms such as “processing,” “computing,” “calculating,” “determining,” or the like, refer to the action and/or processes of a computer or computing system, or similar electronic computing device, that manipulates and/or transforms data represented as physical quantities (e.g., electronic) within the computing system's registers and/or memories into other data similarly represented as physical quantities within the computing system's memories, registers or other such information storage, transmission or display devices. The embodiments are not limited in this context.

The following examples pertain to embodiments in accordance with this Specification. One or more embodiments may provide an apparatus, product, and device to include a porcelain external wall, a touchscreen panel positioned behind the external wall, a graphical display panel positioned behind the external wall, graphical display logic to render a graphical user interface on the graphical display device to be projected through the porcelain external wall, and touch logic to interpret touch interactions with the touchscreen panel received through the porcelain external wall. The porcelain external wall can at least partially obscure presentation of the graphical user interface.

In some implementations, the porcelain external wall is at least partially opaque and hides the graphical display device when not in operation. The porcelain external wall can be at least partially translucent to allow light projected from the graphical display device to be displayed to a user on the porcelain external wall. The porcelain external wall can be curved and the graphical display panel can include a flexible light emitting diode (LED) array. The touchscreen panel can include a capacitive multi-touch panel. The touchscreen device can be integrated in various products such as porcelain wares, cups, plates, among other examples.

One or more embodiments may provide an apparatus, product, and device to include a vessel having an open top, an enclosed bottom, a porcelain exterior wall, an interior wall forming at least a portion of a cavity accessible through the open top, and a touchscreen display module secured between the porcelain exterior wall and interior wall. The touchscreen display module can include a display device to project a graphical user interface through the porcelain exterior wall and a touchscreen panel to receive touch inputs through the porcelain exterior wall.

In some implementations, the interior wall and porcelain exterior wall can be a single comprehensive porcelain surface. The vessel can be one of a cup, mug, bowl, vase, or trophy. The vessel can further incorporate elements such as a wireless network adapter, a microphone, speakers, a battery, and/or a speech and/or voice recognition module. The vessel can further include a wireless charging receiver to receive power from a wireless power transmitter and charge the battery. The wireless power transmitter can be implemented as a saucer or plate to accept the vessel. Speakers and other elements on the vessel can be waterproofed. The vessel can incorporate at least one processor device and a computer-readable memory device with code that executable to provide at least one application. The graphical user interface can be an interface of the application. Applications can include weather reporting applications, news reporting applications, telephony applications, video games, and music player applications, among other examples. In some instances, the at least one processor device includes both a microcontroller processor device and a separate central processing device on a system on chip.

One or more embodiments may provide a method to manufacture, construct, or assemble a porcelain electronics product or device. The method can include positioning a touchscreen display module through a bottom opening of a vessel, where the vessel includes an open top, an exterior porcelain surface defining an exterior wall of the vessel and an interior wall of the vessel. The interior wall can form at least a portion of a cavity accessible through the open top, the bottom opening providing access to a gap between the exterior and interior walls. The touchscreen display module is to be positioned between the exterior and interior walls. The method can further include positioning one or more additional electronic devices within the vessel using the bottom opening and securing a cover to seal the bottom opening and enclose the touchscreen display module and additional electronic devices within the vessel.

In some implementations, the one or more additional electronic devices include a processor mounted to a board, and the method further includes connecting the touchscreen display module to the board and securing the board to the cover. The touchscreen display module can be secured to the exterior wall to facilitate use of the touchscreen display module through the exterior wall. The cover can be made of porcelain (e.g., to match the remaining vessel).

It should be noted that the methods described herein do not have to be executed in the order described, or in any particular order. Moreover, various activities described with respect to the methods identified herein can be executed in serial or parallel fashion.

Although specific embodiments have been illustrated and described herein, it should be appreciated that any arrangement calculated to achieve the same purpose may be substituted for the specific embodiments shown. This disclosure is intended to cover any and all adaptations or variations of various embodiments. It is to be understood that the above description has been made in an illustrative fashion, and not a restrictive one. Combinations of the above embodiments, and other embodiments not specifically described herein will be apparent to those of skill in the art upon reviewing the above description. Thus, the scope of various embodiments includes any other applications in which the above compositions, structures, and methods are used.

It is emphasized that the Abstract of the Disclosure is provided to comply with 37 C.F.R. §1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter that lies in less than all features of a single disclosed embodiment. Thus the following claims are hereby incorporated into the Detailed Description, with each claim standing on its own as a separate preferred embodiment. In the appended claims, the terms “including” and “in which” are used as the plain-English equivalents of the respective terms “comprising” and “wherein,” respectively. Moreover, the terms “first,” “second,” and “third,” etc. are used merely as labels, and are not intended to impose numerical requirements on their objects.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

1.-25. (canceled)

26. A touchscreen device comprising:
a porcelain external wall;
a touchscreen panel positioned behind the external wall;
a graphical display panel positioned behind the external wall;
graphical display logic to render a graphical user interface on the graphical display device to be projected through the porcelain external wall; and
touch logic to interpret touch interactions with the touchscreen panel received through the porcelain external wall,
wherein the porcelain external wall at least partially obscures presentation of the graphical user interface.

27. The touchscreen device of claim 26, wherein the porcelain external wall is at least partially opaque and hides the graphical display device when not in operation.

28. The touchscreen device of claim 27, wherein the porcelain external wall is at least partially translucent to allow light projected from the graphical display device to be displayed to a user on the porcelain external wall.

29. The touchscreen device of claim 26, wherein the porcelain external wall is curved and the graphical display panel comprises a flexible light emitting diode (LED) array.

30. The touchscreen device of claim 26, wherein the touchscreen panel comprises a capacitive multi-touch panel.

31. The touchscreen device of claim 26, wherein the touchscreen device is integrated in a cup.

32. The touchscreen device of claim 26, wherein the touchscreen device is integrated in a plate.

33. A vessel comprising:
an open top;
an enclosed bottom;
a porcelain exterior wall;
an interior wall forming at least a portion of a cavity accessible through the open top; and
a touchscreen display module secured between the porcelain exterior wall and interior wall, wherein the touchscreen display module comprises a display device to project a graphical user interface through the porcelain exterior wall and a touchscreen panel to receive touch inputs through the porcelain exterior wall.

34. The vessel of claim 33, wherein the interior wall and porcelain exterior wall comprise a single comprehensive porcelain surface.

35. The vessel of claim 33, wherein the vessel comprises one of a cup, mug, bowl, vase, or trophy.

36. The vessel of claim 33, further comprising a wireless network adapter.

37. The vessel of claim 33, further comprising a microphone.

38. The vessel of claim 37, further comprising a speech recognition module to interpret voice commands received through the microphone.

39. The vessel of claim 33, further comprising a battery to power a plurality of electronic components disposed within the vessel, wherein the plurality of electronic components comprise the touchscreen display module.

40. The vessel of claim 39, further comprising a wireless charging receiver to receive power from a wireless power transmitter and charge the battery.

41. The vessel of claim 40, wherein the wireless power transmitter comprises a saucer to accept the vessel.

42. The vessel of claim 33, further comprising a water proof speaker.

43. The vessel of claim 33, further comprising at least one processor device, a computer-readable memory device with code stored thereon, the code executable by the processor device to provide at least one application, wherein the graphical user interface is an interface of the application.

44. The vessel of claim 43, wherein the at least one application comprises one or more of a weather reporting application, a news application, a telephony application, a video game, and a music player application.

45. A method comprising:
positioning a touchscreen display module through a bottom opening of a vessel, wherein the vessel comprises an open top, an exterior porcelain surface defining an exterior wall of the vessel and an interior wall of the vessel, the interior wall forms at least a portion of a cavity accessible through the open top, the bottom opening provides access to a gap between the exterior and interior walls, and the touchscreen display module is positioned between the exterior and interior walls;
positioning one or more additional electronic devices within the vessel using the bottom opening;
securing a cover to seal the bottom opening and enclose the touchscreen display module and additional electronic devices within the vessel.
